(19) United States
(12) Patent Application Publication
(10) Pub. No.: US 2026/0099710 A1
(43) Pub. Date: Apr. 9, 2026

(54) MACHINE LEARNING FOR DIRECTED EVOLUTION

(71) Applicant: Solugen, Inc., Houston, TX (US)

(72) Inventors: Carlos Gomez Uribe, Mountain View, CA (US); Japheth Gado, Houston, TX (US)

(73) Assignee: Solugen, Inc., Houston, TX (US)

(21) Appl. No.: 19/349,237

(22) Filed: Oct. 3, 2025

Related U.S. Application Data
(60) Provisional application No. 63/702,919, filed on Oct. 3, 2024.

(51) Int. Cl. G06N 3/08; G06N 3/0464

(52) U.S. Cl. CPC G06N 3/08; G06N 3/0464

(57) ABSTRACT

A method for protein engineering includes generating a fitness library by performing protein language model (PLM)-guided site selection to identify favorable mutagenesis sites and creating protein variants, training a machine learning model to predict protein fitness from sequence data, wherein the machine learning model comprises a convolutional neural network (CNN); and optimizing protein sequences using a phase transition-based algorithm that dynamically updates a score matrix A of dimensions L×20 using cumulative statistics from sampled sequences and implements heating and cooling cycles to maintain system criticality. The CNN has a three-component sequence representation comprising a latent embedding matrix of shape L×1280, a probability matrix of shape L×20, and a feature vector containing 7 values including normalized zero-shot scores, where L represents the number of residues in the protein, wildtype subtraction normalization applied to the latent embedding matrix, dual parallel convolution processing paths, and percentile-based pooling.

### CROSS-REFERENCE TO RELATED APPLICATIONS

This application claims priority to U.S. Provisional Application Ser. No. 63/702,919 entitled “Machine Learning for Directed Evolution” by Gomez et al. and filed on Oct. 3, 2024, which is incorporated herein by reference in its entirety.

### STATEMENT REGARDING FEDERALLY SPONSORED RESEARCH OR DEVELOPMENT

Not applicable.

### TECHNICAL FIELD

The present disclosure relates generally to computational methods and systems for protein engineering and directed evolution. More particularly, the disclosure relates to machine learning-based approaches for predicting protein fitness and optimizing protein sequences, including systems and methods that utilize protein language models, convolutional neural networks, and optimization algorithms configured to identify high-fitness protein variants. The disclosure further relates to computational systems configured to integrate protein screening with machine learning models for accelerated protein design and discovery.

### BACKGROUND

Protein engineering and directed evolution represent critical areas of biotechnology where significant technical challenges have historically limited the efficiency and scope to optimize proteins for with respect to one or more parameters.

Conventional directed evolution methodologies suffer from fundamental scalability problems that severely limit their practical application. For example, conventional approaches typically require 5-10 iterative campaigns to achieve sequences with adequate functionality, with each campaign consuming 1-3 months depending on screening complexity. The conventional approach generally involves multiple resource-intensive steps including DNA mutagenesis, transformation into host organisms, protein production, extraction, and functional evaluation. A typical campaign can only obtain functional measurements for 1,000 to 2,000 protein variants, many of which represent duplicate sequences, creating significant inefficiencies in the protein discovery process.

One of the most significant technical challenges in protein engineering is the exponential growth of possible sequence variants as the number of mutations increases. For example, for a parent protein with 640 sites, the number of possible sequences grows from 1.216×10⁴ for single mutations (relative to the parent protein) to 5.741×10¹⁸ for sequences with six mutations (relative to the parent protein). This exponential increase makes exhaustive computational evaluation impractical, even with advanced machine learning models that can evaluate only 1 million to 100 million sequences within reasonable computational budgets.

While conventional directed evolution focuses on single mutants to maximize laboratory efficiency, such conventional approaches miss potentially superior multi-mutant variants. As such, identifying the rare high-fitness sequences within the vast space of predominantly inactive variants becomes particularly challenging. Conventional approaches for protein sequence space exploration have proven insufficient for addressing the scale and complexity of the problem. For example, conventional simulated annealing methods, while conceptually straightforward, are slow and frequently fail to identify optimal sequences within reasonable timeframes, primarily due to difficulties in designing effective proposal distributions. Genetic algorithms, despite their ability to simulate natural selection and allow recombination events, produce sequences that remain inadequate and are difficult to tune and control. Greedy algorithms, which incrementally build sequences by selecting optimal mutations at each step, consistently become trapped in local optima.

A persistent challenge in protein engineering and directed evolution remains the integration of experimental screening workflows with computational prediction and optimization systems. The need to balance experimental validation costs with computational exploration requirements creates complex optimization problems where the efficiency of the overall protein engineering pipeline depends critically on the allocation of experimental resources guided by computational predictions.

These interconnected technical challenges create a need for improved approaches that can efficiently navigate the vast protein sequence space while maintaining accuracy in prediction and feasibility in experimental validation in protein engineering applications.

### BRIEF SUMMARY OF THE DISCLOSURE

Disclosed herein are various embodiments of computational methods and systems for protein engineering and directed evolution.

For example, In some embodiments, a computer-implemented method for protein engineering comprises generating a fitness library by performing protein language model (PLM)-guided site selection to identify favorable mutagenesis sites and creating protein variants having 2 to 5 mutations relative to a parent protein sequence; training a machine learning model to predict protein fitness from sequence data, wherein the machine learning model comprises a convolutional neural network (CNN), and optimizing protein sequences using a phase transition-based algorithm that dynamically updates a score matrix A of dimensions L×20 using cumulative statistics from sampled sequences and implements heating and cooling cycles to maintain system criticality. The CNN has (i) a three-component sequence representation comprising a latent embedding matrix of shape L×1280, a probability matrix of shape L×20, and a feature vector containing 7 values including normalized zero-shot scores, where L represents the number of residues in the protein, (ii) wildtype subtraction normalization applied to the latent embedding matrix, (iii) dual parallel convolution processing paths, and (iv) percentile-based pooling across eleven specific percentiles: 0.01, 0.025, 0.125, 0.25, 0.375, 0.5, 0.625, 0.75, 0.875, 0.975, and 0.99.

In some embodiments, a convolutional neural network (CNN) for predicting protein of fitness stored on a non-transitory computer-readable medium configured to implement a series steps comprises a three-component sequence representation system, wildtype subtraction normalization applied to the latent embedding matrix to indicate mutated residues, dual parallel convolution processing paths applied separately to embedding and probability matrix representations, percentile-based pooling configured to extract statistical summaries across eleven specific percentiles: 0.01, 0.025, 0.125, 0.25, 0.375, 0.5, 0.625, 0.75, 0.875, 0.975, and 0.99, and a multi-layer perceptron with two hidden layers receiving concatenated outputs from the dual convolution paths and the feature vector.

The three-component sequence representation system comprises: (i) a latent embedding matrix derived from a protein language model, (ii) a probability matrix derived from computed probabilities of amino acids from ESM model output logits, and (iii) a feature vector containing zero-shot scores normalized by mutation count.

In some embodiments, a sequence optimization algorithm for protein engineering stored on a non-transitory computer-readable medium configured to implement a series steps comprises: initializing a score matrix A of dimensions L×20 using scores for all single mutants, where L represents sequence length, sampling N sequences from a Boltzmann distribution based on the score matrix A and temperature T, evaluating the N sequences using a trained machine learning model, dynamically updating the score matrix A using cumulative scores and observation counts according to:

$${A}_{ij} = {A}_{ij} + γ \times std {err}_{ij}$$

where the std errᵢⱼ is computed from tracked statistics of sampled sequences, and implementing heating and cooling cycles to maintain system criticality and prevent sampler collapse.

In some embodiments, a method for protein language model selection comprises: evaluating multiple ESM protein language models for zero-shot prediction of experimental fitness measurements on a training dataset of protein sequences, comparing Spearman correlation coefficients achieved by the multiple ESM models, selecting a model, and using the selected model to generate multi-component sequence representations for protein fitness prediction.

### BRIEF DESCRIPTION OF THE DRAWINGS

For a detailed description of exemplary embodiments of the disclosure, reference will now be made to the accompanying drawings in which:

FIG. 1 is a block diagram illustrating a machine learning-guided process for directed evolution according to an embodiment disclosed herein;

FIG. 2 is a graph illustrating a comparison of performance (Spearman correlation coefficient) of ESM zero-shot scores across different ESM protein language models for predicting experimental fitness measurements on a training dataset of 2,626 sequences;

FIG. 3 is a graph illustrating a comparison of performance (Spearman correlation coefficient) of L2-regularized linear regression models trained on latent embeddings derived from various ESM protein language models, evaluated using five-fold cross-validation across different data splitting strategies;

FIG. 4 is a graph showing training and validation loss curves during machine learning model training with a multi-task objective over approximately 1,500 epochs;

FIG. 5 is a multi-panel graph illustrating optimizer behavior without heating and cooling cycles, showing phase transition characteristics including average ML score, standard deviation, effective number of levels, and temperature traces over optimization iterations;

FIG. 6 is a multi-panel graph demonstrating optimizer performance with heating and cooling cycles, illustrating the benefits of maintaining system criticality through periodic thermal cycling;

FIG. 7 is a histogram showing the distribution of ML scores for sequences with 5 mutations obtained from the disclosed optimizer, compared with single mutant score distributions and wildtype reference score;

FIG. 8 is a multi-panel graph demonstrating optimization failure when the score matrix updating mechanism is disabled, showing substantially lower performance compared to dynamic updating approaches;

FIG. 9 is a graph showing traces of average ML scores as functions of temperature for sequences with different numbers of mutations (n=2 through n=6), along with theoretical model fits demonstrating phase transition behavior;

FIG. 10 is a graph illustrating the variance of ML scores as functions of temperature for sequences with different mutation levels, along with corresponding theoretical model fits showing peak variance at intermediate temperatures;

FIG. 11 is a graph showing traces of the effective number of entries in the Boltzmann distribution after marginalizing to obtain amino acid probabilities, illustrating sampling diversity across different temperatures and mutation levels;

FIG. 12 is a graph presenting traces of the effective number of entries in the Boltzmann distribution after marginalizing to obtain protein site probabilities, demonstrating how the optimization algorithm focuses exploration across sequence positions;

FIG. 13 is a schematic diagram illustrating an embodiment of a computing system including clients, a server system, and a data repository communicably coupled through a network for executing the disclosed machine learning-guided directed evolution process; and

FIG. 14 is a block diagram depicting the operation of the machine learning model, showing the machine learning module coupled to data stores including training data and inputs, and providing outputs based on the disclosed methodology.

### DETAILED DESCRIPTION OF THE DISCLOSED EMBODIMENTS

The following discussion is directed to various exemplary embodiments. However, one skilled in the art will understand that the examples and embodiments disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., the central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

The successful application of machine learning to protein engineering requires models that meet several critical and often conflicting technical requirements. First, models must demonstrate accurate prediction capabilities, correctly forecasting mutation effects with relatively small training datasets. Second, they must exhibit effective extrapolation to unexamined mutations, which may not be represented in training data. This may be particularly important since training data may typically contain predominantly low-fitness variants. Third, models must exhibit satisfactory predictive accuracy for variants with high mutational distances from the wildtype, where conventional approaches fail.

Large-scale machine learning models capable of accurate protein fitness prediction present significant computational challenges. These models often contain billions of parameters and require expensive inference on specialized hardware such as graphics processing units (GPUs). The computational cost of evaluating such sequences creates practical limitations on the number of variants that can be assessed, necessitating sophisticated optimization strategies to efficiently navigate the fitness landscape.

Additionally, effective machine learning for proteins requires sophisticated sequence representation methods that capture the complex relationships between amino acid composition, structure, and function. Approaches such as one-hot encoding, amino acid composition, and physicochemical representations often fail to capture the nuanced patterns necessary for accurate fitness prediction. The challenge lies in developing representations that are both computationally manageable and biologically meaningful.

Disclosed herein are various embodiments of computational methods and systems for protein engineering and directed evolution. The disclosed subject matter addresses the fundamental limitations of conventional directed evolution and existing computational optimization approaches through a comprehensive three-step machine learning-guided process and related system that dramatically reduces both experimental burden and computational inefficiencies.

### Process and System Overview

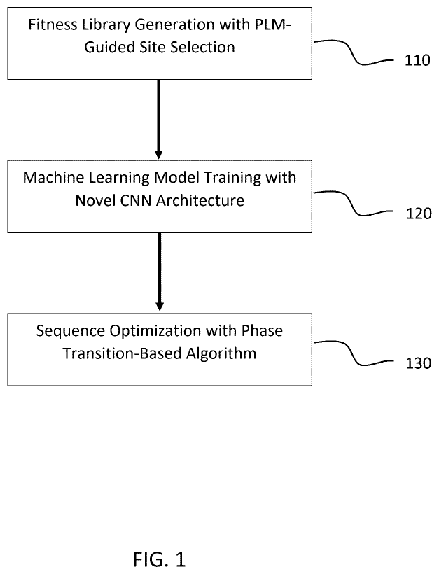

The present disclosure provides a comprehensive machine learning-guided process and a system for performance of the same for directed evolution of proteins, which may dramatically reduce both experimental burden and computational inefficiencies compared to conventional approaches. Referring to FIG. 1, a machine learning-guided process 100 for directed evolution is shown. In the embodiment of FIG. 1, the process generally includes three steps that integrate experimental screening with computational prediction and optimization.

Step 1: Fitness Library Generation with PLM-Guided Site Selection

In the embodiment of FIG. 1, the first step 110 of the disclosed workflow may include generating a training dataset through protein language model (PLM)-guided site selection and controlled mutagenesis strategies. Unlike conventionally relied upon random mutagenesis, the disclosed approach utilizes rational knowledge integrated with predictive scores from protein language models to identify residues that are “favorable” for mutagenesis.

More particularly, in some embodiments, the process and/or system may employ a suitable PLM, such as one of the ESM family of models, to assess mutational favorableness at each sequence position. For example, the process and/or system may utilize the ESM2-t33-650M-UR50D model, based on comparative analysis showing optimal performance for both zero-shot prediction and linear model embedding approaches across a training dataset of 2,626 sequences.

In some embodiments, the mutagenesis strategy may combine site-saturated mutagenesis at chosen sites with single mutations, and random mutagenesis at selected sites to generate variants with multiple mutations, typically ranging from 2 to 5 mutations with respect to a parent sequence. In embodiments where cost considerations permit, the system enables direct synthesis of full-length protein sequences, providing precise control over mutated sites, specific amino acids introduced, and statistical distribution of mutational distances.

This targeted mutagenesis strategy avoids the predominance of inactive variants characteristic of random approaches, thereby creating a more informative training dataset that efficiently utilizes experimental resources while maintaining broad sequence space coverage.

Step 2: Machine Learning Model Training with Novel CNN Architecture

Referring again to the embodiment of FIG. 1, the second step 120 may include training a machine learning model to predict experimental fitness based solely on protein sequence, for example intentionally excluding structural and evolutionary information to eliminate computational bottlenecks. As disclosed herein, the machine learning model may comprise architecture configured to address critical requirements of accurate prediction, effective extrapolation, and maintained accuracy at high mutational distances.

For example, in some embodiments, the machine learning model employs a sequence representation system. For example, the model may employ a multi-component (e.g., three-component) sequence representation derived from the ESM2-t33-650M-UR50D model. The sequence representation system may comprise: (1) a latent embedding matrix of shape L×1280, where L represents the number of residues in the protein, providing 1280-dimensional vectors for each residue; (2) a probability matrix of shape L×20, derived from computed probabilities of amino acids from the ESM model output logits; and (3) a feature vector containing 7 values, including three zero-shot scores (wildtype marginal, mutant marginal, and log-likelihood), these scores normalized by mutation count, and the total number of mutations.

In some embodiments, the sequence representation system may employ wildtype subtraction normalization, where the embedding matrix of each mutant sequence is normalized by subtracting the wildtype embedding matrix. This normalization specifically indicates mutated residues since embeddings of non-mutated residues are zeroed out in the subtraction, enabling the model to focus on functionally relevant sequence changes.

In some embodiments, the machine learning model exhibits a convolutional neural network (CNN) Architecture with percentile-based pooling. For example, the disclosed machine learning model may employ CNNs to enable a parameter-sharing capability, which enables capture of nonlinear interactions across sequence positions and facilitates generalization to unseen sequence positions. The CNN architecture may apply convolutional layers to both embedding and probability matrix representations through dual parallel processing paths.

In some embodiments, in the first convolution path, a convolution layer is applied followed by dropout, then statistics are computed across the sequence dimension to generate vectors for specified percentiles. In some embodiments, conventional mean pooling may be replaced with percentile-based pooling across multiple percentiles, for example, eleven (11) specific percentiles: 0.01, 0.025, 0.125, 0.25, 0.375, 0.5, 0.625, 0.75, 0.875, 0.975, and 0.99. This statistical summary may be effective to provide a better representation of the convolved output compared to single-value pooling approaches.

In some embodiments, the second convolution path may compute statistical summaries before applying convolution, with both paths applied separately to embedding and probability matrices. Outputs may be flattened and concatenated with the zero-shot score feature vector, then fed into a multi-layer perceptron with two hidden layers.

In some embodiments, the machine learning model exhibits multi-task learning implementation. The machine learning model may implement multi-task learning to address varying measurements from different experimental conditions. The output regression layer may simultaneously predict across all tasks using shared activations, enabling more robust sequence representations and additional regularization. Targets may be standardized to a mean of 0.0 and a standard deviation of 1.0, with a weighted mean square error (MSE) loss across tasks. In some embodiments, training may employ a suitable optimizer, for example, the AdamW optimizer with cosine annealing scheduler over approximately 1,500 epochs using 80% training and 20% validation data splits.

Step 3: Sequence Optimization with Phase Transition-Based Algorithm

Referring again to the embodiment of FIG. 1, the third step 130 may deploy the trained model through a novel optimization algorithm, for example, which may efficiently explore a sequence space to identify high-fitness variants. Given computational budgets limiting evaluation to 1 million to 100 million sequences, the disclosed optimization algorithm may address the fundamental challenge of finding rare high-fitness sequences within exponentially large sequence spaces.

In some embodiments, the optimization algorithm initializes with a score matrix A of dimensions L×20, where L represents sequence length, computed from all single mutant scores. The optimization algorithm samples N sequences (for example, 1,000 sequences) from a Boltzmann distribution based on the score matrix and temperature T, with mutations selected according to probabilities proportional to e^{(Aij/T)}.

In some embodiments, the disclosed optimization algorithm exhibits phase transition behavior reminiscent of physical systems, characterized by sudden transitions from low-score states to high-score states. The key quantities measured are average energy (E) and variance (Var(E)). Generally, average Energy ( [symbol] E [symbol] ) refers to the expected value of the energy distribution. Also, generally, variance (Var(E)) refers to a measure of the spread of the energy distribution.

The sequence scores are like negative energies, given the sign difference in the sampling distribution relative to a Boltzmann distribution from physics, and its energy. Generally, the Number of Effective Levels (n_{eff}) refers to the effective number of energy levels defined as:

$${n}_{eff} = 2 {\sum }_{i = 1}^{L} {p}_{i} \cdot i - 1$$

where pᵢ is a probability mass function (PMF) with L entries sorted from most likely to least likely, for example, a scaled average of the rank of the order statistic. The n_{eff} may be computed in two ways, a first based on the marginal sampling distribution over amino acids, and a second based on the marginal sampling distribution over sites.

To understand the phase transition behavior, a simple model may be considered, where the energy levels Eᵢ are sampled from a mixture of two Gaussian distributions:

$$ρ ( E ) ∼ ϵ 𝒩 ( {μ}_{1} , {σ}_{1}^{2} ) + ( 1 - ϵ ) 𝒩 ( {μ}_{2} , {σ}_{2}^{2} ) \qquad ( 2 )$$

Here, ∈<<1 is the fraction of samples from the first component with a high ML score, and 1−∈ is the fraction of samples from the second component with a poor ML score. It is assumed that μ₁=μ₂−δ with δ>0, in that these are viewed as energies rather than scores here, and assume σ₁²>σ₂² as seen in the data. The key quantities are then given by the following equations:

### Average Energy:

$$〈 E 〉 = α ( {μ}_{1} - {σ}_{1}^{2} ) - ( 1 - α ) ( {μ}_{2} - {σ}_{2}^{2} β ) \qquad ( 3 )$$

where α is the proportion of sequences from the high-scoring mode, μ₁ and μ₂ are the means of the high and low score distributions, and σ² and σ² are their variances.

### Variance:

$$Var ( E ) = α {σ}_{1}^{2} + ( 1 - α ) {σ}_{2}^{2} + α ( 1 - α ) {δ}^{2} \qquad ( 4 )$$

where δ is the interaction term between the high and low score modes.

### Effective Number of Levels:

$${n}_{eff} = 2 L ( α Φ ( - {βσ}_{1} ) + ( 1 - α ) Φ ( - {βσ}_{2} ) ) \qquad ( 5 )$$

where φ is the cumulative distribution function of the standard normal distribution, and L is the number of sites.

The proportion of sequences from the high-scoring mode a is core to these equations, and defined as:

$$α = \frac{ϵ {e}^{- β {μ}_{1} + \frac{{β}^{2} {σ}_{1}^{2}}{2}}}{ϵ {e}^{- β {μ}_{1} + \frac{{β}^{2} {σ}_{1}^{2}}{2}} + ( 1 - ϵ ) {e}^{- β {μ}_{2} + \frac{{β}^{2} {σ}_{2}^{2}}{2}}}$$

As β increases, α→1, and as β decreases, α→∈. These equations capture the phase-transition-like behavior of the key quantities observed during the optimization runs as disclosed herein. Deriving these equations involves approximations based on large L and mean-field considerations, which are detailed herein.

Initially, the optimizer may process many iterations with low average ML scores, and may exhibit sudden increases in both average score and variance, indicating discovery of high-fitness regions.

In some embodiments, the scoring algorithm may implement heating and cooling cycles that maintain relatively high average scores and variances across multiple iterations to maintain system criticality and prevent sampler collapse.

In some embodiments, the score matrix may be updated using cumulative scores and observation counts from the unique sequences sampled so far across all iterations. Specifically, the sum of scores and the sum of the squared scores for each mutation may be tracked and applied via the update rules as follow:

$$sum of {scores}_{ij} = {\sum }_{k} f ( {S}_{k} ) \times {δ}_{k , i , j} \qquad ( 1 )$$

$$sum of scores {squared}_{ij} = {\sum }_{k} {f ( {S}_{k} )}^{2} \times {δ}_{k , i , j}$$

$$observation {counts}_{ij} = {\sum }_{k} {δ}_{k , i , j}$$

$${M}_{ij} = \frac{sum of {scores}_{ij}}{o b s e r vation {counts}_{ij}}$$

$$variance = \frac{sum of scores {squared}_{ij}}{o b s e r vation {counts}_{ij}}$$

$$std {err}_{i j} = \sqrt{\frac{v a r i a n c {e}_{ij}}{o b s e r v ation {counts}_{ij}}}$$

$${A}_{i j} = {A}_{i j} + γ \times std {err}_{ij}$$

where β_{k,i,j} is an indicator function that is 1 if the k-th sequence has mutation i→j, and 0 otherwise, and γ is a constant typically set to 1.0 or so as to enable some explore-exploit behavior to avoid local optima. In some embodiments, the first three quantities may be updated using the new unique sequences scored in the latest iteration.

Temperature adjustments may follow cooling schedules, with heating applied after phase transitions to maintain exploration capability. If fewer than 500 high-scoring sequences are identified, temperature is increased by 50% to prevent sampler collapse.

The optimization behavior of the machine learning model may be characterized through a theoretical model based on a combination of two Gaussian distributions representing high-scoring and low-scoring sequence populations. Key quantities including average energy, variance, and effective number of levels are described through mathematical equations that capture phase-transition-like behavior. The proportion of sequences from a high-scoring mode, a, may be defined through temperature-dependent expressions that explain the sudden transitions observed during optimization runs.

### System Integration and Performance

The complete three-step system effectively identifies high-fitness protein variants, for example, within 500 optimization iterations, designing libraries of approximately 1,000 sequences with high predicted fitness for experimental screening. The integrated approach enables evaluation budgets of 1 million to 100 million sequences while successfully identifying rare, high-fitness sequences within vast predominantly inactive sequence spaces.

The disclosed system provides dramatic improvements over conventional directed evolution, reducing required screening campaigns from 5-10 to approximately 2, while yielding superior multi-mutant sequences typically missed by single-mutation focused approaches. Additionally, the approach maintains predictive accuracy for variants 5-10 mutations away from wildtype, enabling discovery of significantly improved protein variants that outperform sequences found through conventional methods.

As illustrated in FIG. 1, the complete process integrates experimental and computational components via a process that optimizes allocation of experimental resources while maximizing discovery of functionally superior protein variants.

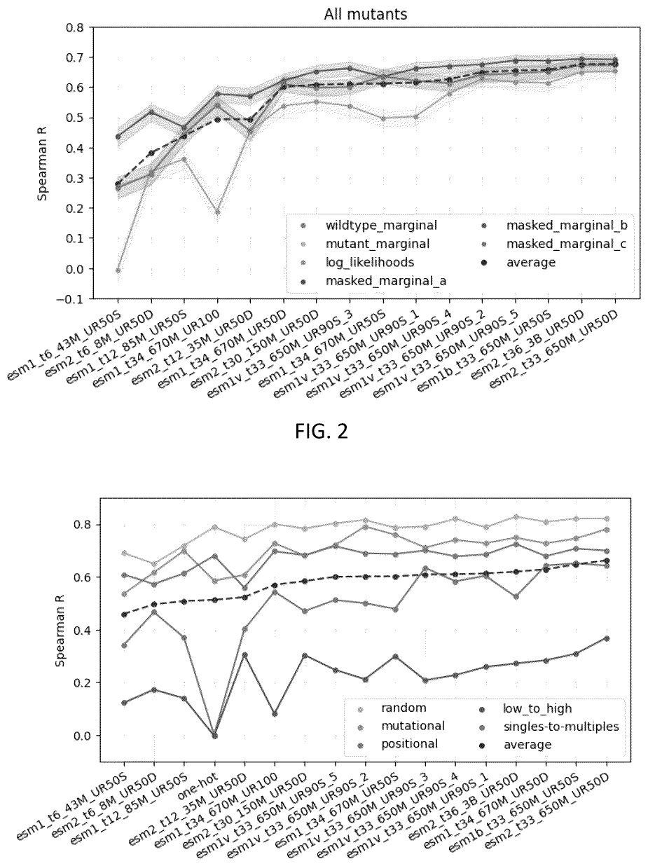

### Detailed Description of FIG. 2: ESM Model Performance Comparison for Zero-Shot Prediction

FIG. 2 illustrates a comparison of performance across different ESM (Evolutionary Scale Modeling) protein language models for zero-shot prediction of experimental fitness measurements. FIG. 2 demonstrates the systematic evaluation process used to select the optimal protein language model for the disclosed sequence representation system.

Particularly, FIG. 2 displays Spearman correlation coefficients for various ESM models evaluated on the training dataset of 2,626 sequences. Multiple zero-shot scoring methods are compared across different ESM model variants, including wildtype_marginal, mutant_marginal, log_likelihoods, and several masked_marginal approaches. The x-axis shows different ESM models ranging from smaller variants like esm1_t6_43M_UR50S to larger models such as esm2_t36_3B_UR50D.

FIG. 1 clearly demonstrates that ESM2-t33-650M-UR50D achieves optimal performance among the evaluated models, with correlation coefficients consistently reaching approximately 0.7-0.8 across different scoring methods. This superior performance validated the selection of ESM2-t33-650M-UR50D as the protein language model of choice for generating the three-component sequence representation system disclosed herein.

The comparative analysis shown in FIG. 2 illustrates performance trends across model architectures and sizes. FIG. 2 shows that the ESM2-t33-650M-UR50D model outperforms both smaller variants that lack sufficient capacity and some larger models that may exhibit diminishing returns for this specific application.

### Detailed Description of FIG. 3: ESM Embeddings Linear Model Performance

FIG. 3 demonstrates the performance comparison of L2-regularized linear models trained on latent embeddings derived from various ESM protein language models. This analysis complements the zero-shot evaluation in FIG. 2 by assessing how well different ESM models provide useful feature representations for downstream machine learning tasks.

FIG. 3 displays Spearman correlation coefficients achieved by linear regression models trained on embeddings averaged over residues, evaluated using five-fold cross-validation on the training dataset of 2,626 sequences. Various data splitting strategies are compared, including random, low-to-high, mutational, singles-to-multiples, and positional splits, along with a baseline one-hot encoding approach.

FIG. 3 confirms that ESM2-t33-650M-UR50D consistently delivers superior performance across all evaluation strategies, achieving correlation coefficients approaching 0.8. This validates the model selection not only for zero-shot prediction capabilities but also for providing high-quality embedding representations that support effective machine learning model training. The comparison with one-hot encoding demonstrates the substantial advantage of using pretrained protein language model embeddings, with ESM-based approaches achieving significantly higher correlations than traditional sequence encoding methods. The consistent performance across different data splitting strategies indicates robust generalization capabilities essential for the disclosed extrapolation requirements.

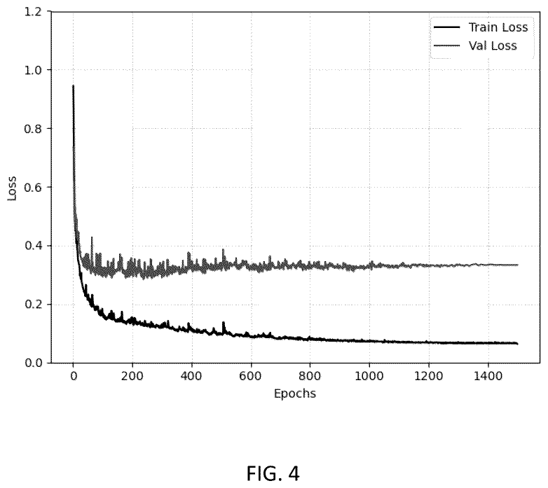

### Detailed Description of FIG. 4: Model Training Performance

FIG. 4 illustrates the training and validation loss curves during the machine learning model training process with the multi-task objective. FIG. 4 demonstrates the effective convergence of the disclosed CNN architecture with percentile-based pooling over approximately 1,500 training epochs.

FIG. 4 shows both training loss and validation loss traces, with the training loss depicted as a solid line and validation loss as a dashed line. Both loss curves demonstrate steady convergence from initial values around 1.2 to final values approaching 0.2, indicating effective learning without significant overfitting. The close tracking between training and validation losses throughout the training process demonstrates that the disclosed model architecture successfully avoids overfitting while achieving strong predictive performance.

The smooth convergence behavior illustrated in FIG. 4 validates the effectiveness of the disclosed machine learning model, including the percentile-based pooling mechanism, wildtype subtraction normalization, and multi-task learning approach. The consistent decrease in both training and validation losses over 1,500 epochs confirms the model's ability to learn meaningful patterns from the protein sequence representations while maintaining generalization capability.

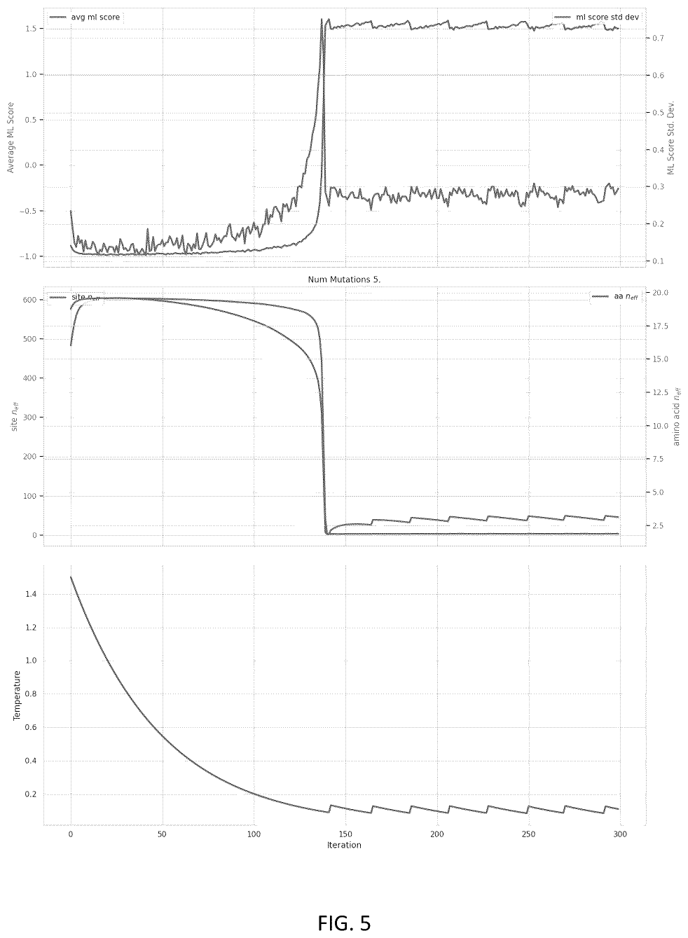

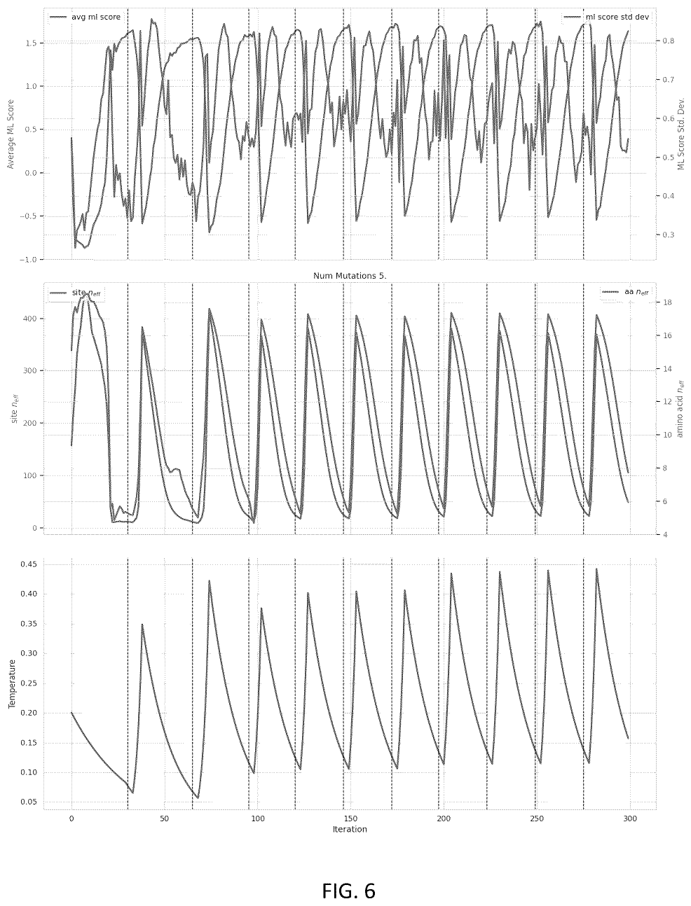

Detailed Description of FIG. 5: Phase Transition Behavior without Heating and Cooling

Referring to FIG. 5, the fundamental phase transition behavior exhibited by the disclosed optimization algorithm during a run without heating and cooling cycles. FIG. 5 demonstrates the optimization algorithm's ability to transition from low-score states to high-score states.

The upper panel of FIG. 5 shows the average ML score and standard deviation traces over approximately 300 optimization iterations. The average ML score trace demonstrates the characteristic phase transition behavior, where the optimizer initially processes many iterations with low average ML scores (around −0.5), followed by a sudden dramatic increase to higher scores (approaching 1.0). This sharp transition occurs around iteration 200 and indicates the optimization algorithm's discovery of high-fitness sequence regions within the search space.

The ML score standard deviation trace shows corresponding behavior, with low variance initially, followed by a spike in variance coinciding with the phase transition, then stabilization at higher variance levels. This variance behavior is crucial for maintaining exploration capability and preventing the optimization from collapsing into sampling only a few high-scoring sequences repetitively.

The middle panel displays site number of n_{eff} and amino acid n_{eff} traces showing the effective number of levels for both site and amino acid distributions. The site n_{eff} reaches values of approximately 600, while amino acid n_{eff} peaks around 20, indicating the optimization algorithm's ability to identify favorable mutations across multiple sequence positions. Both metrics show dramatic changes during the phase transition, reflecting the optimization algorithm's shift from broad sequence space exploration to focused sampling of high-fitness regions.

The temperature trace in the lower panel shows the cooling schedule applied throughout the optimization run. The temperature decreases from an initial value around 1.4 to approximately 0.2, following a standard simulated annealing cooling protocol. The phase transition occurs as temperature decreases, demonstrating the optimization algorithm's temperature-dependent behavior characteristic of physical phase transitions.

Detailed Description of FIG. 6: Enhanced Performance with Heating and Cooling Cycles

FIG. 6 demonstrates the enhanced optimization performance achieved through the disclosed heating and cooling cycle methodology that maintains system criticality. FIG. 6 shows how periodic thermal cycling prevents sampler collapse and enables sustained high performance throughout the optimization run.

The average ML score and standard deviation traces in the upper panel of FIG. 6 show more complex behavior compared to FIG. 5, with multiple peaks and sustained high variance levels. The average scores reach similar peak values (around 1.0) but maintain elevated levels through multiple heating and cooling cycles rather than a single transition. The standard deviation remains relatively high (0.3-0.8) throughout most iterations, indicating continued exploration capability.

The heating and cooling cycles are clearly visible in the temperature trace, where temperature is periodically increased by 50% to prevent sampler collapse when fewer than 500 high-scoring sequences are identified. This thermal cycling maintains the system at criticality, ensuring that many iterations have relatively high average scores and variances.

The site n_{eff} and amino acid n_{eff} behavior shows more sustained activity compared to FIG. 5, with continued fluctuations indicating ongoing exploration of different sequence regions. This demonstrates the advantage of the heating and cooling approach in maintaining diversity in the sampled sequences while consistently identifying high-fitness variants.

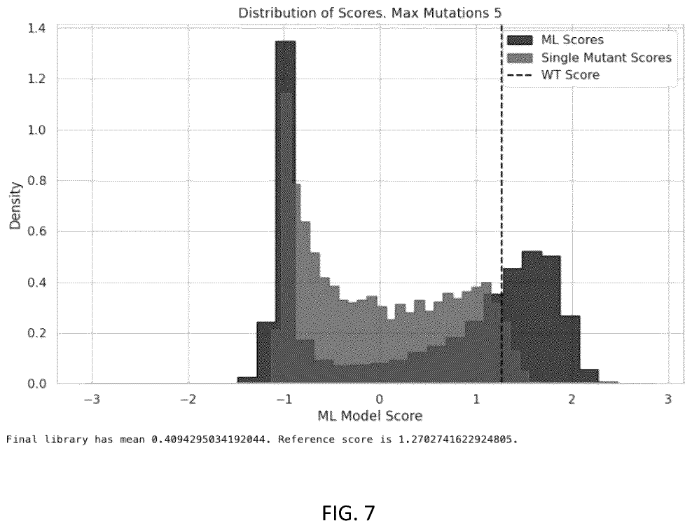

### Detailed Description of FIG. 7: Successful “Needles in Haystack” Discovery

FIG. 7 provides compelling evidence that the disclosed optimization algorithm successfully identifies rare high-fitness sequences within the vast protein sequence space.

The ML scores distribution shows sequences discovered by the disclosed optimizer, with a mean score of 0.409 and significant representation in the high-score region (scores above 0). This distribution demonstrates a clear shift toward higher fitness compared to random sampling approaches. The single mutant scores distribution represents the baseline performance achievable through traditional single-mutation approaches, showing predominantly negative scores with occasional positive variants. The contrast between these distributions highlights the superior performance of the disclosed multi-mutant optimization approach in accessing sequence regions with significantly improved fitness.

The wildtype (WT) score is marked at 1.27, representing the reference sequence performance. While the final library mean of 0.409 remains below the wildtype score, the distribution shows the optimization algorithm's ability to identify sequences approaching and potentially exceeding wildtype performance through the combination of multiple beneficial mutations.

The successful identification of high-scoring sequences within the exponentially large sequence space (up to 5.741×10¹⁸ possible sequences for 6 mutations) demonstrates the practical effectiveness of the disclosed phase transition-based optimization algorithm. This represents a significant advancement over conventional optimization methods that fail to efficiently navigate such vast search spaces.

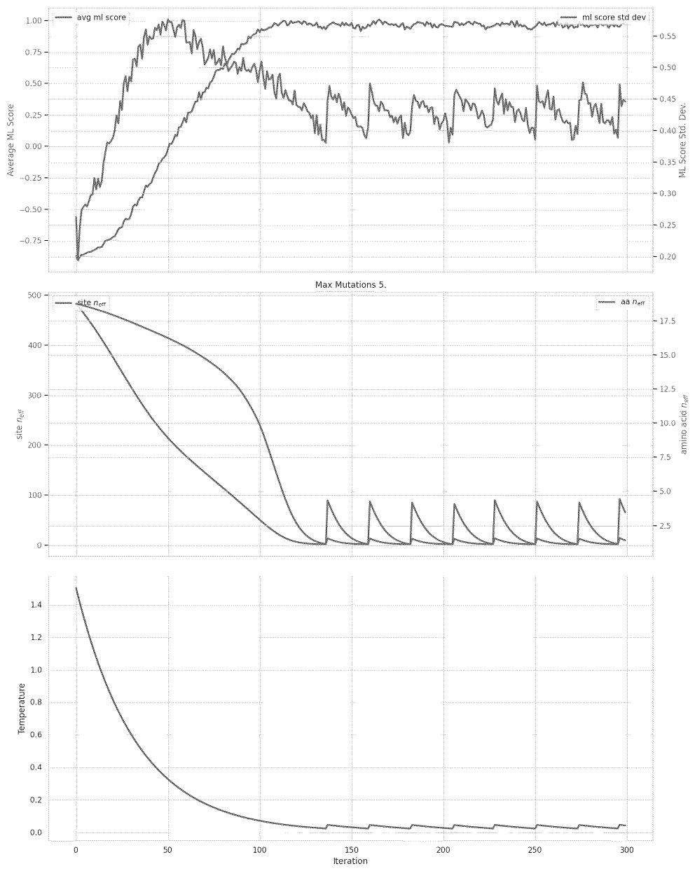

### Detailed Description of FIG. 8: Critical Importance of Dynamic Score Matrix Updating

FIG. 8 provides demonstrates the importance of the dynamic score matrix updating mechanism disclosed herein. FIG. 8 demonstrates optimization failure when the score matrix updating feature is disabled, emphasizing the essential nature of the feedback loop between the sampler and ML model predictions.

More particularly, with the score matrix held fixed throughout the run, the average ML score remains substantially lower (around −0.25) compared to successful runs shown in FIGS. 5 and 6. The optimization fails to achieve the phase transition behavior characteristic of the disclosed algorithm, instead showing only modest improvements that remain well below the reference sequence score.

The absence of phase transition behavior is clearly visible, with gradual score improvements rather than the sudden transitions observed with dynamic updating enabled. This demonstrates that without the cumulative statistics tracking and real-time score matrix updates, the optimizer cannot discover high-scoring sequences.

The temperature trace shows similar cooling behavior to successful runs, indicating that temperature control alone is insufficient for effective optimization. As disclosed herein, dynamically updating the score matrix using cumulative scores and observation counts from unique sequences sampled across iterations yields effective optimization. This comparison validates the theoretical framework underlying the disclosed optimization algorithm and demonstrates that updating the score matrix achieves the phase transition behavior that enables efficient exploration of vast protein sequence spaces. The figure clearly demonstrates that without this feedback mechanism, the optimizer remains trapped in low-fitness regions and fails to discover the rare high-fitness sequences that represent the primary objective of the directed evolution process.

The complete set of optimization behavior illustrated in FIGS. 5, 6, 7, and 8 validates the theoretical framework based on mixture of Gaussian distributions and demonstrates the optimization algorithm's practical capability to efficiently explore sequence spaces containing up to 10¹⁸ potential sequences while identifying libraries of approximately 1,000 high-fitness candidates for experimental validation.

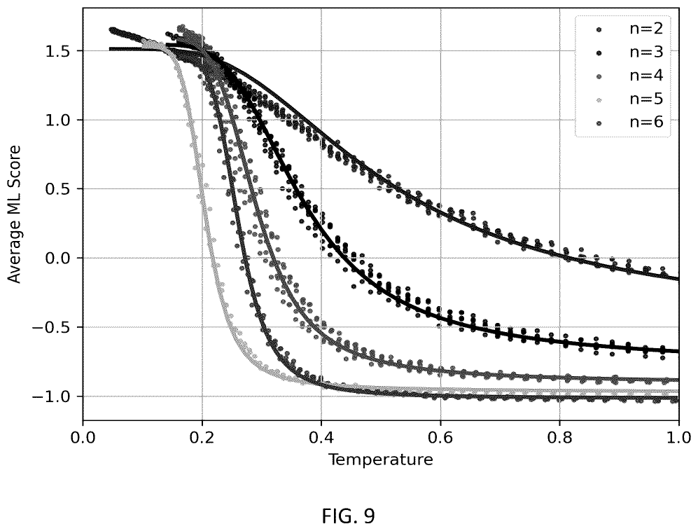

Detailed Description of FIG. 9: Average Score Temperature Dependence with Theoretical Fits

FIG. 9 demonstrates the theoretical validation of the phase transition model by showing traces of average ML scores as functions of temperature for sequences with different numbers of mutations (n=2 through n=6). FIG. 9 demonstrates that the disclosed optimization algorithm exhibits behavior consistent with physical phase transition phenomena. The experimental data points show the characteristic S-shaped curves typical of phase transitions, with sharp transitions occurring at intermediate temperatures. At high temperatures (low p values), average scores remain low, corresponding to broad exploration of sequence space. As temperature decreases, the system undergoes sharp transitions to high-score states, demonstrating the optimization algorithm's ability to discover rare high-fitness sequences.

The theoretical model fits, shown as continuous lines, demonstrate excellent agreement with the experimental optimization data across all mutation levels. The fitted curves capture both the transition temperatures and the magnitude of score improvements, validating the mixture of Gaussian distributions model described in the theoretical framework. Higher mutation levels (n=5, n=6) show more pronounced transitions, reflecting the increased difficulty of finding high-fitness sequences in larger combinatorial spaces.

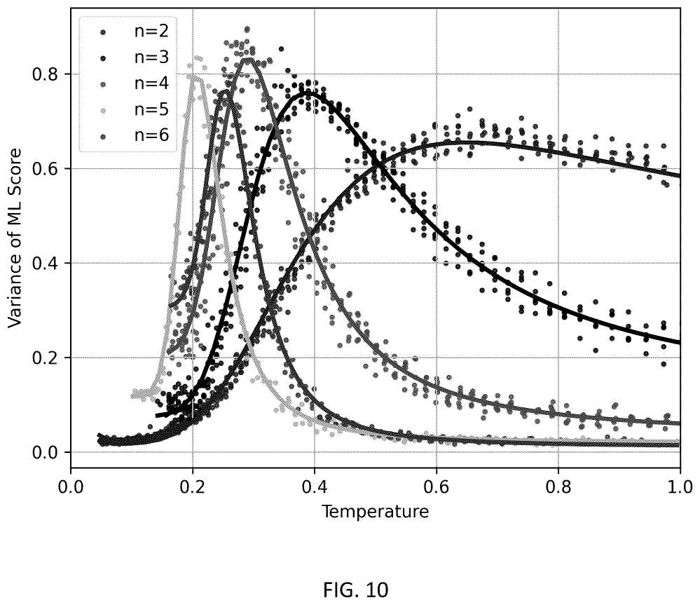

### Detailed Description of FIG. 10: Score Variance Temperature Dependence

FIG. 10 illustrates the variance of ML scores as functions of temperature for sequences with different mutation levels, along with corresponding theoretical model fits. FIG. 10 demonstrates the emergence of peak variance at intermediate temperatures that maintains system criticality.

The experimental data reveals distinct peaks in score variance occurring at intermediate temperatures for all mutation levels. These variance peaks coincide with the phase transition regions shown in FIG. 9, indicating the coexistence of both high-scoring and low-scoring sequence populations during critical transitions. At extreme temperatures, variance approaches zero as the system either explores uniformly (high temperature) or samples exclusively from high-scoring regions (low temperature).

The theoretical fits accurately capture this peak behavior through the mixture model framework, where variance is given by Var(E)=ασ₁²+(1−α)σ₂²+α(1−α)δ². The interaction term α(1−α)δ² creates the characteristic variance peak when the proportion a of high-scoring sequences is approximately 0.5, explaining the criticality maintenance observed in the optimization runs.

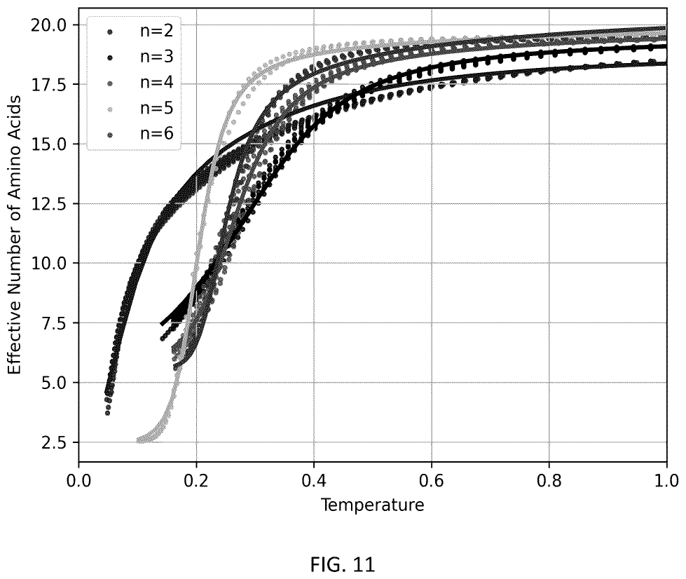

### Detailed Description of FIG. 11: Effective Number of Amino Acids

FIG. 11 shows traces of the effective number of entries in the Boltzmann distribution after marginalizing to obtain amino acid probabilities. FIG. 11 quantifies the diversity of amino acid sampling achieved by the disclosed optimization algorithm across different temperatures and mutation levels. The effective number of amino acids typically ranges from 2.5 to 20, representing the breadth of amino acid exploration during optimization. At high temperatures, the optimization algorithm samples broadly across amino acid types, approaching the theoretical maximum of 20 amino acids. As temperature decreases, the effective number drops sharply during phase transitions, indicating focused sampling of beneficial amino acid substitutions.

The theoretical fits demonstrate good agreement with experimental data, validating the model's ability to predict amino acid sampling diversity. Higher mutation levels (n=5, n=6) show more dramatic transitions, reflecting the optimization algorithm's ability to identify specific amino acid combinations that contribute to high fitness in multi-mutant sequences.

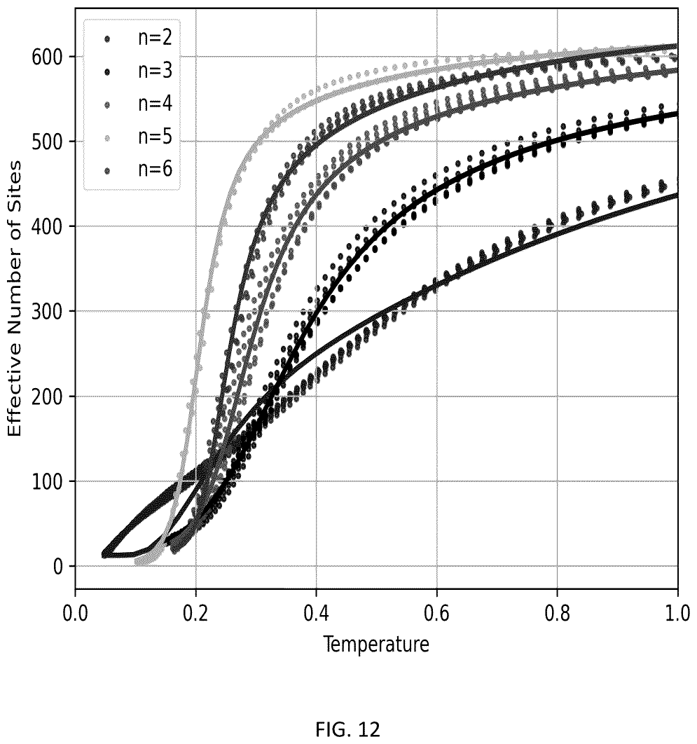

### Detailed Description of FIG. 12: Effective Number of Sites

FIG. 12 presents traces of the effective number of entries in the Boltzmann distribution after marginalizing to obtain protein site probabilities. FIG. 12 illustrates how the optimization algorithm focuses exploration across different sequence positions during the search for high-fitness variants. The effective number of sites can reach values of several hundred, indicating the optimization algorithm's ability to explore mutations across many sequence positions simultaneously. At high temperatures, site sampling is broadly distributed across the protein sequence. During phase transitions, the effective number of sites decreases sharply as the optimization algorithm identifies and focuses on particularly favorable mutagenesis sites.

The theoretical model captures the site-sampling behavior through the n_{eff} calculation based on marginal sampling distributions. The sharp transitions observed in FIG. 12 correspond to the optimization algorithm's discovery of critical sequence positions that contribute disproportionately to fitness improvements. This site-focused behavior demonstrates how the disclosed optimization algorithm efficiently navigates large sequence spaces by concentrating exploration on the most promising regions.

### System

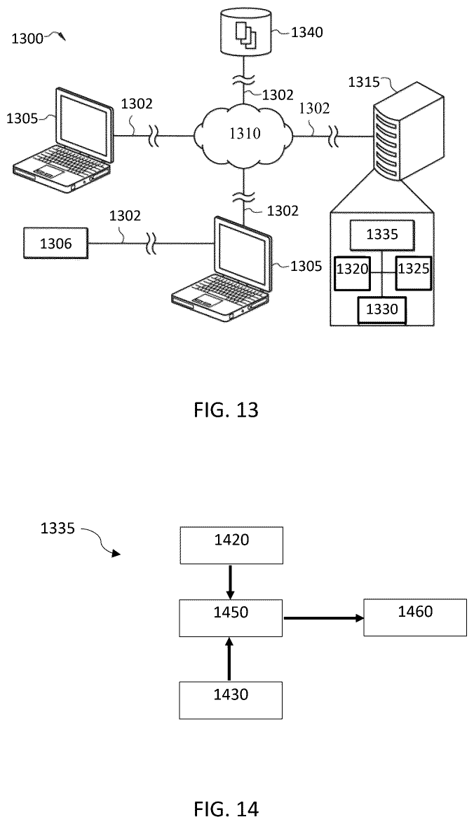

In some embodiments, the machine-learning model as disclosed herein is illustrated in the context of FIG. 13. For example, FIG. 13 illustrates an embodiment of a computing system 1300 that includes a number of clients 1305, a server system 1315, and a data repository 1340 communicably coupled through a network 1310 by one or more communication links 1302 (e.g., wireless, wired, or a combination thereof). The computing system 1300, generally, can execute applications and analyze data received from sensors, such as may be acquired in the performance of the methods disclosed herein. For instance, the computing system 1300 may execute a machine-learning model 1335 to as disclosed herein.

In general, the server system 1315 can be any server that stores one or more hosted applications, such as, for example, the machine-learning model 1335. In some instances, the machine-learning model 1335 may be executed via requests and responses sent to users or clients within and communicably coupled to the illustrated computing system 1300. In some instances, the server system 1315 may store a plurality of various hosted applications, while in other instances, the server system 1315 may be a dedicated server meant to store and execute only a single hosted application, such as the machine-learning model 1335.

In some instances, the server system 1315 may comprise a web server, where the hosted applications represent one or more web-based applications accessed and executed via network 1310 by the clients 1305 of the system to perform the programmed tasks or operations of the hosted application. At a high level, the server system 1315 can comprise an electronic computing device operable to receive, transmit, process, store, or manage data and information associated with the computing system 1300. Specifically, the server system 1315 illustrated in FIG. 13 can be responsible for receiving application requests from one or more client applications associated with the clients 1305 of computing system 1300 and responding to the received requests by processing the requests in the associated hosted application and sending the appropriate response from the hosted application back to the requesting client application.

In addition to requests from the clients 1305, requests associated with the hosted applications may also be sent from a third party 1306, such as internal users, external or third-party customers, other automated applications, as well as any other appropriate entities, individuals, systems, or computers. As used in the present disclosure and as described in more detail herein, the term “computer” is intended to encompass any suitable processing device. For example, although FIG. 13 illustrates a single server system 1315, a computing system 1300 can be implemented using two or more server systems 1315, as well as computers other than servers, including a server pool. The server system 1315 may be any computer or processing device such as, for example, a blade server, general-purpose personal computer (PC), Macintosh, workstation, UNIX-based workstation, or any other suitable device. In other words, the present disclosure contemplates computers other than general-purpose computers, as well as computers without conventional operating systems. Further, the illustrated server system 1315 may be adapted to execute any operating system, including Linux, UNIX, Windows, Mac OS, or any other suitable operating system.

In the illustrated embodiment, and as shown in FIG. 13, the server system 1315 includes a processor 1320, an interface 1330, a memory 1325, and the machine-learning model 1335. The interface 1330 is used by the server system 1315 for communicating with other systems in a client-server or other distributed environment (including within computing system 1300) connected to the network 1310 (e.g., clients 1305, as well as other systems communicably coupled to the network 1310). Generally, the interface 1330 comprises logic encoded in software and/or hardware in a suitable combination and operable to communicate with the network 1310. More specifically, the interface 1330 may comprise software supporting one or more communication protocols associated with communications such that the network 1310 or interface's hardware is operable to communicate physical signals within and outside of the illustrated computing system 1300.

Although illustrated as a single processor 1320 in FIG. 13, two or more processors may be used according to particular needs, desires, or particular embodiments of computing system 1300. Each processor 1320 may be a central processing unit (CPU), a blade, an application-specific integrated circuit (ASIC), a field-programmable gate array (FPGA), or another suitable component. Generally, the processor 1320 executes instructions and manipulates data to perform the operations of server system 1315 and, specifically, the machine-learning model 1335. Specifically, the server's processor 1320 executes the functionality required to receive and respond to requests from the clients 1305 and their respective client applications, as well as the functionality required to perform the other operations of the machine-learning model 1335.

Regardless of the particular implementation, “software” may include computer-readable instructions, firmware, wired or programmed hardware, or any combination thereof on a tangible medium operable when executed to perform at least the processes and operations described herein. Each software component may be fully or partially written or described in any appropriate computer language including C, C++, C#, Java, Visual Basic, assembler, Perl, any suitable version of 4GL, as well as others. It will be understood that while portions of the software implemented in the context of the embodiments disclosed herein may be shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate. In the illustrated computing system 1300, processor 1320 executes one or more hosted applications on the server system 1315.

At a high level, the machine-learning model 1335 is any application, program, module, process, or other software that may execute, change, delete, generate, or otherwise manage information according to the present disclosure, particularly in response to and in connection with one or more requests received from the illustrated clients 1305 and their associated client applications. In certain cases, only one machine-learning model 1335 may be located at a particular server system 1315. In others, a plurality of related and/or unrelated modeling systems may be stored at a server system 1315, or located across a plurality of other server systems 1315, as well. In certain cases, computing system 1300 may implement a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, the hosted applications may represent web-based applications accessed and executed by clients 1305 or client applications via the network 1310 (e.g., through the Internet).

Further, while illustrated as internal to server system 1315, one or more processes associated with machine-learning model 1335 may be stored, referenced, or executed remotely. For example, a portion of the machine-learning model 1335 may be a web service associated with the application that is remotely called, while another portion of the machine-learning model 1335 may be an interface object or agent bundled for processing at a client 1305 located remotely. Moreover, any or all of the machine-learning model 1335 may be a child or sub-module of another software module or enterprise application (not illustrated) without departing from the scope of this disclosure. Still further, portions of the machine-learning model 1335 may be executed by a user working directly at server system 1315, as well as remotely at clients 1305.

The server system 1315 also includes memory 1325. Memory 1325 may include any memory or database module and may take the form of volatile or non-volatile memory. The illustrated computing system 1300 of FIG. 13 also includes one or more clients 1305. Each client 1305 may be any computing device operable to connect to or communicate with at least the server system 1315 and/or via the network 1310 using a wireline or wireless connection.

The illustrated data repository 1340 may be any database or data store operable to store data, such as data received from a sensor. Generally, the data may comprise inputs to the machine-learning model 1335, historical information, operational information, and/or output data from the machine-learning model 1335.

The functionality of one or more of the components disclosed with respect to FIG. 13, such as the server system 1315 or the clients 1305, can be carried out on a computer or other device comprising a processor (e.g., a desktop computer, a laptop computer, a tablet, a server, a smartphone, smartwatch, or some combination thereof). Generally, such a computer or other computing device may include a processor (which may be referred to as a central processor unit or CPU) that is in communication with memory devices including secondary storage, read-only memory (ROM), random access memory (RAM), input/output (I/O) devices, and network connectivity devices. The processor may be implemented as one or more CPU chips.

FIG. 14 depicts an example of the operation of the machine-learning model 1335 of FIG. 13. In the embodiment of FIG. 14, the machine-learning model 1335 comprises a machine-learning module 1450 coupled to one or more data stores, for example, data within the data repository 1340. For instance, in the embodiment of FIG. 14, the data within the data repository 1340 of FIG. 13 may include data from a training data store 1420 and/or inputs 1430.

As also shown in FIG. 14, the machine-learning module 1450 can access data, such as data from the training data store 1420, receive inputs 1430, and provide an output 1460 based upon the inputs 1430 and data retrieved from the training data store 1420. Generally, the machine-learning module 1450 utilizes data stored in the training data store 1420, for example, sensor data as disclosed herein, to enable the machine-learning module 1450 to predictively determine the state of a subject based upon additional sensor data evaluated by the machine-learning module 1450.

In some embodiments, at least a portion of the data stored in the training data store 1420 may be characterized as “training data” that is used to train the machine-learning module 1450. As will be appreciated by the ordinarily-skilled artisan upon viewing the instant disclosure, although the Figures illustrate an aspect in which the training data are stored in a single “store” (e.g., at least a portion of the training data store 1420), additionally or alternatively, in some embodiments the training data may be stored in multiple stores in one or more locations. Additionally, in some embodiments, the training data (e.g., at least a portion of the data stored in the training data store 1420) may be subdivided into two or more subgroups, for example, a training data subset, one or more evaluation and/or testing data subsets, or combinations thereof.

Having described various systems, processes, and algorithms, certain aspect can include, but are not limited to:

In a first aspect, a computer-implemented method for protein engineering comprises: generating a fitness library by performing protein language model (PLM)-guided site selection to identify favorable mutagenesis sites and creating protein variants having 2 to 5 mutations relative to a parent protein sequence; training a machine learning model to predict protein fitness from sequence data, wherein the machine learning model comprises a convolutional neural network (CNN) having: (i) a three-component sequence representation comprising a latent embedding matrix of shape L×1280, a probability matrix of shape L×20, and a feature vector containing 7 values including normalized zero-shot scores, where L represents the number of residues in the protein, (ii) wildtype subtraction normalization applied to the latent embedding matrix, (iii) dual parallel convolution processing paths, and (iv) percentile-based pooling across eleven specific percentiles: 0.01, 0.025, 0.125, 0.25, 0.375, 0.5, 0.625, 0.75, 0.875, 0.975, and 0.99; and optimizing protein sequences using a phase transition-based algorithm that dynamically updates a score matrix A of dimensions L×20 using cumulative statistics from sampled sequences and implements heating and cooling cycles to maintain system criticality.

A second aspect can include the method of the first aspect, wherein the fitness library generation comprises site-saturated mutagenesis at selected sites to produce single mutations and random mutagenesis to generate variants with multiple mutations.

A third aspect can include the method of the first or second aspect, wherein the three-component sequence representation further comprises normalizing the zero-shot scores by dividing by the number of mutations in each variant.

A fourth aspect can include the method of any one of the first to third aspects, wherein the dual parallel convolution processing paths comprise: a first path applying convolution followed by dropout, then computing statistics across the sequence dimension to generate vectors for the eleven specified percentiles; and a second path computing statistical summaries before applying convolution, followed by flattening the output.

A fifth aspect can include the method of any one of the first to fourth aspects, wherein the machine learning model implements multi-task learning with an output regression layer that simultaneously predicts across multiple experimental conditions using shared activations.

A sixth aspect can include the method of any one of the first to fifth aspects, wherein the phase transition-based optimization algorithm comprises: initializing the score matrix A using scores for all single mutants; sampling N sequences from a Boltzmann distribution based on the score matrix A and temperature T, with mutations selected according to probabilities proportional to e^{(Aij/T)}; evaluating the N sequences using the trained machine learning model; and updating the score matrix A using update rules:

$$sum of {scores}_{ij} = {\sum }_{k} f ( {S}_{k} ) \times {δ}_{k , i , j}$$

$$observation {counts}_{ij} = {\sum }_{k} {δ}_{k , i , j}$$

$${A}_{i j} = {A}_{i j} + γ \times std {err}_{ij}$$

where δ_{k,i,j} is an indicator function and γ is typically set to 1.0.

A seventh aspect can include the method of the sixth aspect, wherein the heating and cooling cycles comprise increasing temperature T by 50% when fewer than 500 high-scoring sequences are identified to prevent sampler collapse.

An eighth aspect can include the method of any one of the first to seventh aspects, wherein the phase transition-based algorithm exhibits behavior characterized by sudden transitions from low-score states to high-score states, with the optimization behavior modeled using a mixture of two Gaussian distributions representing high-scoring and low-scoring sequence populations.

A ninth aspect can include the method of any one of the first to eighth aspects, wherein the method reduces required screening campaigns from 5-10 to approximately 2 campaigns while identifying high-fitness protein variants within 500 optimization iterations.

In a tenth aspect, a computing system for protein engineering comprising: a processor; a memory coupled to the processor; and a machine learning model stored in the memory and executable by the processor to perform the method of any one of the first to ninth aspects.

An eleventh aspect can include the computing system of the tenth aspect, further comprising a server system communicably coupled to one or more clients through a network, wherein the server system hosts the machine learning model and processes protein sequence optimization requests.

In a twelfth aspect, a convolutional neural network (CNN) for predicting protein of fitness stored on a non-transitory computer-readable medium configured to implement a series steps comprises: a three-component sequence representation system comprising: (i) a latent embedding matrix derived from a protein language model, (ii) a probability matrix derived from computed probabilities of amino acids from ESM model output logits, and (iii) a feature vector containing zero-shot scores normalized by mutation count; wildtype subtraction normalization applied to the latent embedding matrix to indicate mutated residues; dual parallel convolution processing paths applied separately to embedding and probability matrix representations; percentile-based pooling configured to extract statistical summaries across eleven specific percentiles: 0.01, 0.025, 0.125, 0.25, 0.375, 0.5, 0.625, 0.75, 0.875, 0.975, and 0.99; and a multi-layer perceptron with two hidden layers receiving concatenated outputs from the dual convolution paths and the feature vector.

A thirteenth aspect can include the CNN of the twelfth aspect, wherein the percentile-based pooling replaces traditional mean pooling to provide a richer statistical representation of convolved output.

A fourteenth aspect can include the CNN of the twelfth or thirteenth aspect, further comprising multi-task learning implementation with an output regression layer that simultaneously predicts across different experimental conditions using shared activations.

A fifteenth aspect can include the CNN of any one of the twelfth to fourteenth aspects, wherein training employs an optimizer with cosine annealing scheduler over approximately 1,500 epochs using 80% training and 20% validation data splits.

In a sixteenth aspect, a sequence optimization algorithm for protein engineering stored on a non-transitory computer-readable medium configured to implement a series steps comprising: initializing a score matrix A of dimensions L×20 using scores for all single mutants, where L represents sequence length; sampling N sequences from a Boltzmann distribution based on the score matrix A and temperature T; evaluating the N sequences using a trained machine learning model; dynamically updating the score matrix A using cumulative scores and observation counts according to:

$${A}_{ij} = {A}_{lj} + γ \times std {err}_{ij}$$

where the std errᵢⱼ is computed from tracked statistics of sampled sequences; and implementing heating and cooling cycles to maintain system criticality and prevent sampler collapse.

A seventeenth aspect can include the algorithm of the sixteenth aspect, wherein the algorithm exhibits phase transition behavior characterized by sudden transitions from low-score states to high-score states.

An eighteenth aspect can include the algorithm of the sixteenth or seventeenth aspect, wherein the optimization behavior is modeled using a theoretical framework based on a mixture of two Gaussian distributions with proportion a of sequences from a high-scoring mode defined as:

$$α = \frac{ϵ {e}^{- {βμ}_{1} + \frac{{β}^{2} {σ}_{1}^{2}}{2}}}{ϵ {e}^{- {βμ}_{1} + \frac{{β}^{2} {σ}_{1}^{2}}{2} + {( 1 - ϵ )}^{- {βμ}_{2} + \frac{{β}^{2} {σ}_{2}^{2}}{2}}}} .$$

A nineteenth aspect can include the algorithm of any one of the sixteenth to eighteenth aspects, wherein the algorithm is configured to identify high-fitness protein variants within computational budgets of 1 million to 100 million sequence evaluations.

In a twentieth aspect, a method for protein language model selection comprises: evaluating multiple ESM protein language models for zero-shot prediction of experimental fitness measurements on a training dataset of protein sequences; comparing Spearman correlation coefficients achieved by the multiple ESM models; selecting a model; and using the selected model to generate multi-component sequence representations for protein fitness prediction.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A computer-implemented method for protein engineering comprising:
generating a fitness library by performing protein language model (PLM)-guided site selection to identify favorable mutagenesis sites and creating protein variants having 2 to 5 mutations relative to a parent protein sequence;
training a machine learning model to predict protein fitness from sequence data, wherein the machine learning model comprises a convolutional neural network (CNN) having:
(i) a three-component sequence representation comprising a latent embedding matrix of shape L×1280, a probability matrix of shape L×20, and a feature vector containing 7 values including normalized zero-shot scores, where L represents the number of residues in the protein,
(ii) wildtype subtraction normalization applied to the latent embedding matrix,
(iii) dual parallel convolution processing paths, and
(iv) percentile-based pooling across eleven specific percentiles: 0.01, 0.025, 0.125, 0.25, 0.375, 0.5, 0.625, 0.75, 0.875, 0.975, and 0.99; and
optimizing protein sequences using a phase transition-based algorithm that dynamically updates a score matrix A of dimensions L×20 using cumulative statistics from sampled sequences and implements heating and cooling cycles to maintain system criticality.

2. The method of claim 1, wherein the fitness library generation comprises site-saturated mutagenesis at selected sites to produce single mutations and random mutagenesis to generate variants with multiple mutations.

3. The method of claim 1, wherein the three-component sequence representation further comprises normalizing the zero-shot scores by dividing by the number of mutations in each variant.

4. The method of claim 1, wherein the dual parallel convolution processing paths comprise:
a first path applying convolution followed by dropout, then computing statistics across the sequence dimension to generate vectors for the eleven specified percentiles; and
a second path computing statistical summaries before applying convolution, followed by flattening the output.

5. The method of claim 1, wherein the machine learning model implements multi-task learning with an output regression layer that simultaneously predicts across multiple experimental conditions using shared activations.

6. The method of claim 1, wherein the phase transition-based optimization algorithm comprises:
initializing the score matrix A using scores for all single mutants;
sampling N sequences from a Boltzmann distribution based on the score matrix A and temperature T, with mutations selected according to probabilities proportional to e^{(Aij/T)};
evaluating the N sequences using the trained machine learning model; and
updating the score matrix A using update rules:
$$sum of {scores}_{ij} = {\sum }_{k} f ( {S}_{k} ) \times {δ}_{k , i , j}$$
$$observation {counts}_{ij} = {\sum }_{k} {δ}_{k , i , j}$$
$${A}_{i j} = {A}_{ij} + γ \times std {err}_{ij}$$
where δ_{k,i,j} is an indicator function and γ is typically set to 1.0.

7. The method of claim 6, wherein the heating and cooling cycles comprise increasing temperature T by 50% when fewer than 500 high-scoring sequences are identified to prevent sampler collapse.

8. The method of claim 1, wherein the phase transition-based algorithm exhibits behavior characterized by sudden transitions from low-score states to high-score states, with the optimization behavior modeled using a mixture of two Gaussian distributions representing high-scoring and low-scoring sequence populations.

9. The method of claim 1, wherein the method reduces required screening campaigns from 5-10 to approximately 2 campaigns while identifying high-fitness protein variants within 500 optimization iterations.

10. A computing system for protein engineering comprising:
a processor;
a memory coupled to the processor; and
a machine learning model stored in the memory and executable by the processor to perform the method of claim 1.

11. The computing system of claim 10, further comprising a server system communicably coupled to one or more clients through a network, wherein the server system hosts the machine learning model and processes protein sequence optimization requests.

12. A convolutional neural network (CNN) for predicting protein of fitness stored on a non-transitory computer-readable medium configured to implement a series steps comprising:
a three-component sequence representation system comprising:
(i) a latent embedding matrix derived from a protein language model,
(ii) a probability matrix derived from computed probabilities of amino acids from ESM model output logits, and
(iii) a feature vector containing zero-shot scores normalized by mutation count;
wildtype subtraction normalization applied to the latent embedding matrix to indicate mutated residues;
dual parallel convolution processing paths applied separately to embedding and probability matrix representations;
percentile-based pooling configured to extract statistical summaries across eleven specific percentiles: 0.01, 0.025, 0.125, 0.25, 0.375, 0.5, 0.625, 0.75, 0.875, 0.975, and 0.99; and
a multi-layer perceptron with two hidden layers receiving concatenated outputs from the dual convolution paths and the feature vector.

13. The CNN of claim 12, wherein the percentile-based pooling replaces traditional mean pooling to provide a richer statistical representation of convolved output.

14. The CNN of claim 12, further comprising multi-task learning implementation with an output regression layer that simultaneously predicts across different experimental conditions using shared activations.

15. The CNN of claim 12, wherein training employs an optimizer with cosine annealing scheduler over approximately 1,500 epochs using 80% training and 20% validation data splits.

16. A sequence optimization algorithm for protein engineering stored on a non-transitory computer-readable medium configured to implement a series steps comprising:
initializing a score matrix A of dimensions L×20 using scores for all single mutants, where L represents sequence length;
sampling N sequences from a Boltzmann distribution based on the score matrix A and temperature T;
evaluating the N sequences using a trained machine learning model;
dynamically updating the score matrix A using cumulative scores and observation counts according to:
$${A}_{i j} = {A}_{ij} + γ \times std {err}_{ij}$$
where the std errᵢⱼ is computed from tracked statistics of sampled sequences; and
implementing heating and cooling cycles to maintain system criticality and prevent sampler collapse.

17. The algorithm of claim 16, wherein the algorithm exhibits phase transition behavior characterized by sudden transitions from low-score states to high-score states.

18. The algorithm of claim 16, wherein the optimization behavior is modeled using a theoretical framework based on a mixture of two Gaussian distributions with proportion a of sequences from a high-scoring mode defined as:
$$α = \frac{ϵ {e}^{- {βμ}_{1} + \frac{{β}^{2} {σ}_{1}^{2}}{2}}}{ϵ {e}^{- {βμ}_{1} + \frac{{β}^{2} {σ}_{1}^{2}}{2} + {( 1 - ϵ )}^{- {βμ}_{2} + \frac{{β}^{2} {σ}_{2}^{2}}{2}}}} .$$

19. The algorithm of claim 16, wherein the algorithm is configured to identify high-fitness protein variants within computational budgets of 1 million to 100 million sequence evaluations.

20. A method for protein language model selection comprising:
evaluating multiple ESM protein language models for zero-shot prediction of experimental fitness measurements on a training dataset of protein sequences;
comparing Spearman correlation coefficients achieved by the multiple ESM models;
selecting a model; and
using the selected model to generate multi-component sequence representations for protein fitness prediction.
